(19) United States
(12) Patent Application Publication
(10) Pub. No.: US 2024/0093549 A1
(43) Pub. Date: Mar. 21, 2024

(54) FENESTRATION APPARATUS INCORPORATING LIQUID CRYSTAL GLAZING AND RELATED METHODS

(71) Applicant: CORNING INCORPORATED, Corning, NY (US)

(72) Inventors: Thomas Bertin-Mourot, Paris (FR); Anthony Robert Board, Breesport, NY (US); James Gregory Couillard, Ithaca, NY (US)

(21) Appl. No.: 18/038,290

(22) PCT Filed: Nov. 29, 2021
(86) PCT No.: PCT/US2021/060967

§ 371 Date: May 23, 2023

Related U.S. Application Data
(60) Provisional application No. 63/119,114, filed on Nov. 30, 2020.

(51) Int. Cl. E06B 9/24; C03C 17/00; C03C 17/34; E06B 3/28

(52) U.S. Cl. CPC E06B 9/24; C03C 17/002; C03C 17/3423; E06B 3/28; E06B 2009/2464

(57) ABSTRACT

In various embodiments of the present disclosure, a fenestration apparatus is provided, including: a glazing comprising a LC panel having: a first glass layer; a second glass layer, and a liquid crystal cell therebetween; a frame, configured perimetrically around a corresponding perimetrical edge of the LC panel; and an attachment member configured to the frame, wherein the attachment member is configured to be removably fixable to an existing window, wherein the attachment member is configured to define a gap between the frame, the at least one LC panel, and the existing window.

### CROSS-REFERENCE TO RELATED APPLICATIONS

This application claims the benefit of priority under 35 U.S.C. § 119 of U.S. Provisional Application No. 63/119,114, filed Nov. 30, 2020, the content of which is incorporated herein by reference in its entirety.

### FIELD OF THE INVENTION

Broadly, the present disclosure is directed towards embodiments of a fenestration apparatus (e.g. sometimes called a secondary glazing system) incorporating thin glass laminate(s). More specifically, the fenestration apparatuses are configured for retrofit installation onto an existing fenestration assembly (e.g. window, door, or other fenestration opening(s) and/or architectural glazing(s)). More specifically, the present disclosure is directed towards various embodiments of an apparatus, and related methods of use, for a fenestration apparatus having at least one thin glass laminate, in accordance with the present disclosure.

### BACKGROUND

Many older buildings were built with single pane windows, which due to relatively poor insulation value lead to high heating and air conditioning costs and do not provide optimal inhabitant comfort. Retrofitting to install double or triple pane windows would require significant expense and disruption. Such a retrofit may not even be possible due to historic or landmark designation of the building, or if the building framework is not capable of handling the additional glass weight. The older windows of older buildings have limited performance, including limited thermal insulation, limited acoustic dampening, and an inability to filter undesired wavelengths of light (e.g. UV or infrared). Improved performance is desired.

### SUMMARY

The present disclosure is a thin glass laminate in a frame which can be installed within or surrounding an existing single pane window. This secondary glazing system (SGS) is easy to install and can be easily removed for window cleaning, which is important for commercial high-rise buildings. By adding a second air cavity (e.g. or third air cavity, in instances of a dual-pane supplemental glazing system) the fenestration apparatuses of the present disclosure significantly improve energy performance of the single-pane windows. The present disclosure uses a thin glass laminate, with almost half the weight of a single glass pane (e.g. when compared to conventional architectural glass thicknesses). The laminate can also be designed to qualify as safety glazing under ANSI Z97.1 or EN 12600 standards, thereby providing additional safety and security to the inhabitants.

In some embodiments, the apparatus is an architectural product.

In one aspect, a fenestration apparatus is provided, comprising: at least one glazing comprising a liquid crystal panel (LC panel), wherein the liquid crystal panel comprises: a first glass layer; a second glass layer, and a liquid crystal material therebetween; a frame, configured perimetrically around a corresponding perimetrical edge of the LC panel; a seal, configured between the frame and the LC panel; and an attachment member configured to the frame, wherein the attachment member is configured to be removably fixable to an existing window, wherein the attachment member is configured to define a gap between the frame, the at least one LC panel, and the existing window.

In some embodiments, the attachment member comprises a compression member.

In some embodiments, the attachment member comprises an expandable gasket and a release member.

In some embodiments, the attachment member comprises a mechanical attachment member, wherein the mechanical attachment member is configured to cooperate in mating engagement with a corresponding existing fenestration assembly.

In some embodiments, the frame is configured with a base, configured to retain on an existing window frame and/or alongside an existing window frame assembly.

In some embodiments, the frame is configured with at least two upward extensions along the perimetrical edge of the glass laminate, such that the first extension is configured alongside the first glass layer and the second extension is configured alongside the second glass layer.

In some embodiments, the existing window comprises an adjacent perimetrical ledge/extension.

In some embodiments, the fenestration assembly further comprises a wireless power member.

In some embodiments, the fenestration assembly further comprises a second glazing in spaced relation from the first major surface of the LC panel, wherein the second glazing and the LC panel define a gap therebetween.

In some embodiments, the second glazing is a single layer of glass, or a glass laminate.

In some embodiments, the second glazing comprises a third layer of glass and a fourth layer of glass retained together with a third interlayer.

In some embodiments, the third layer of glass and fourth layer of glass are each selected from: strengthened boro-aluminosilicate glass, unstrengthened boro-aluminosilicate glass, strengthened soda lime glass, and unstrengthened soda lime glass.

In some embodiments, at least one of the third layer and fourth layer comprise a boro-aluminosilicate glass having a thickness of not greater than 1 mm.

In some embodiments, at least one of the third layer and fourth layer comprise a soda lime glass having a thickness of between 2 mm and 6 mm.

In some embodiments, the third interlayer is selected from: a polyester, a polyurethane, an ionomer, and/or combinations thereof.

In some embodiments, the second glazing comprises a layer of boro-aluminosilicate glass having a thickness of between 0.5 mm and not greater than 1 mm.

In some embodiments, the second glazing comprises a single layer of soda lime glass having a thickness selected from the range of between 2 mm and not greater than 6 mm.

In some embodiments, the first interlayer and second interlayer each comprise a thickness of not greater than 2.5 mm.

In some embodiments, the first interlayer and second interlayer each comprise a polymer.

In some embodiments, the first interlayer and second interlayer are each selected from: a polymer, a polyester, a polyurethane, an ionomer, and/or combinations thereof.

In some embodiments, the first interlayer and second interlayer comprise one of: a polyvinyl butyral (PVB), a thermoplastic polyurethane (TPU), a PET, and combinations thereof.

In some embodiments, the laminate comprises a coating on at least one of: the first major surface of the LC panel, the second major surface of the LC panel, and both the first major surface of the LC panel and the second major surface of the LC panel.

In some embodiments, the fenestration apparatus is a removable secondary glazing assembly.

In some embodiments, the interlayer is a tinted polymer configured for light absorption.

In some embodiments, the fenestration apparatus passes a safety glazing test as set out in ANSI Z97.1 or EN 12600 standard, when measured in accordance with the standard.

In one aspect, a fenestration apparatus, comprising: a first glazing comprising a liquid crystal panel (LC panel), wherein the liquid crystal panel comprises: a first glass layer; a second glass layer, and a liquid crystal cell therebetween; a second glazing comprising at least a first glass layer, wherein the second glazing is configured in spaced relation from the first glazing to define a gap therebetween; a frame, configured perimetrically around a corresponding perimetrical edge of the first glazing and second glazing to retain the first glazing and second glazing in spaced relation; a seal, configured between the frame and an edge of the first glazing and an edge of the second glazing to define a sealed gap therebetween; and an attachment member configured to the frame, wherein the attachment member is configured to be removably fixable to an existing window, wherein the attachment member is configured to define a gap between the frame, the at least one LC panel, and the existing window.

In some embodiments, the second glazing comprises a glass laminate having the first glass layer attached to a second glass layer, via a second glazing interlayer positioned between the third glass layer and fourth glass layer.

In some embodiments, the second glazing has a thickness of 0.5 mm to not greater than 6 mm thick.

In some embodiments, the sealed gap is configured with an insulating gas.

In some embodiments, the attachment member comprises an expandable gasket and a release member.

In some embodiments, the fenestration assembly further comprises a wireless power member.

In some embodiments, at least one of the first glazing and second glazing are configured with a coating.

In some embodiments, the coating is selected from the group consisting of: a low emissivity coating, an anti-reflective coating; a tint coating; an easy clean coating; or an anti-bird strike coating

In some embodiments, the coating is configured on at least one of: a first surface of the first glazing, a second surface of the first glazing, a first surface of the second glazing, and a second surface of the second glazing.

In some embodiments, the fenestration apparatus is a removable secondary glazing assembly.

In some embodiments, at least one of the first interlayer, the second layer, and the second glazing interlayer is a tinted polymer configured for light absorption.

In some embodiments, the fenestration apparatus passes a safety glazing test as set out in ANSI Z97.1 or EN 12600 standard, when measured in accordance with the standard.

In some embodiments, at least one of the first glass layer and the second glass layer of the first glazing is a chemically strengthened glass.

In some embodiments, the second glazing is a laminate having a thickness of less than 3 mm.

In some embodiments, the second laminate comprises: a first glass layer having a thickness of not greater than 0.5 mm; a second glass layer having a thickness of not greater than 0.5 mm; and an interlayer configured between the first and second layer, wherein the interlayer comprises PVB.

In some embodiments, the first layer of the second glazing is an inorganic glass.

In some embodiments, the first layer of the second glazing is an alkaline earth boro-aluminosilicate glass.

In some embodiments, the second layer of the second glazing is an inorganic glass.

In some embodiments, the second layer of the second glazing is an alkaline earth boro-aluminosilicate glass.

In some embodiments, the frame is configured with thermal insulating material.

In one aspect, a method is provided, comprising: configuring a fenestration apparatus along an existing fenestration assembly comprising an existing window and an existing frame; actuating a removably fixable attachment member on the fenestration apparatus; and securing the fenestration apparatus over at least the existing window of the existing fenestration assembly via the removable fixable attachment member, thereby providing a retrofit window assembly having a gap between the fenestration apparatus and the existing window, wherein the retrofit window assembly is configured with at least one improved performance attribute as compared to the existing fenestration assembly.

In some embodiments, the retrofit window assembly is configured with acoustic dampening; increased insulation, tailored light filtering, safety glazing performance when measured in accordance with ANSI Z97.1 or EN 12600 standards, and combinations thereof.

In some embodiments, the securing step further comprises: positioning the frame and at least one glass pane within the existing frame, such that the weight of the secondary glazing system is retained by the existing window frame.

In some embodiments, the sealing engagement further comprises positioning the secondary glazing system alongside the existing frame, such that the weight of the secondary glazing system is retained by the attachment member to the attachment locations along the existing window frame.

In some embodiments, the securing step further comprises: positioning the frame and at least one glass pane along at least a portion of the existing frame and along at least a portion of the existing edge, such that the weight of the secondary glazing system is retained by the existing window frame and the at least one attachment member configured to the attachment locations along the existing window frame.

In some embodiments, the laminate thickness range is at least 0.5 mm to not greater than 2.5 mm. In some embodiments, the laminate thickness range is at least 0.75 mm to not greater than 2.5 mm. In some embodiments, the laminate thickness range is at least 0.75 mm to not greater than 2 mm. In some embodiments, the laminate thickness range is at least 1 mm to not greater than 2.75 mm.

In some embodiments, the laminate thickness is not greater not greater than 3 mm; not greater than 2.5 mm; not greater than 2 mm; or not greater than 1.5 mm. In some embodiments, the laminate thickness is at least 2.9 mm; at least 2.5 mm; at least 2.7 mm; at least 1.5 mm; at least 1.3 mm; or at least 1 mm.

In some embodiments, the interlayer layer thickness is at least 0.3 mm to not greater than 2.4 mm. In some embodiments, the interlayer layer thickness is at least 0.5 mm to not greater than 2 mm.

In some embodiments, the interlayer layer thickness is at least 0.75 mm to not greater than 2 mm. In some embodiments, the interlayer layer thickness is at least 0.5 mm to not greater than 1 mm. In some embodiments, the interlayer layer thickness is at least 0.75 mm to not greater than 1.5 mm. In one embodiment, the first laminate comprises a first glass sheet having a thickness of 0.5 mm, a second glass sheet having a thickness of 0.5 mm, and an interlayer thickness of 0.3 mm. In one embodiment, the laminate comprises a first glass layer having a thickness of 0.5 mm, a second glass layer having a thickness of 0.5 mm, and an interlayer thickness of 0.76 mm.

As some non-limiting examples, the coating includes: a low emissivity coating, an anti-reflective coating; a tint coating; an easy clean coating; or an anti-bird strike coating. In some embodiments, the coating is a partial coating. In some embodiments, the coating is a full coating. In some embodiments (e.g. anti-bird strike coating), the coating is patterned along discrete portions of the surface.

In some embodiments, the laminate comprises a low emissivity coating on at least one of: a first major surface of the first glass layer, a second major surface of the second glass layer, and both the first major surface of the first glass layer and the second major surface of the second glass layer.

For example, the low emissivity coating can be comprised of a combination of metals and oxides, including non-limiting examples of silicon nitride, metallic silver, silicon dioxide, tin oxide, zirconium oxide, and/or combinations thereof, to name a few.

In some embodiments, the interlayer is an acoustic dampening polymer configured for noise reduction.

In some embodiments, the fenestration apparatus is a removable secondary glazing assembly.

In some embodiments, the interlayer is a tinted polymer configured for light absorption. In various embodiments, the tinted polymer interlayer is configurable to absorb at least some UV light, infra-red light, visible light, and/or combinations thereof.

In some embodiments, the fenestration apparatus passes a safety glazing test as set out in ANSI Z97.1 or EN 12600 standard, when measured in accordance with the standard.

In one embodiment, the defined gap is filled with non-reactive gas (e.g. configured to promote better thermal performance). Non-limiting examples of gas in the first or second defined gap include: inert gas (e.g. Kr, Ar), air, and mixtures thereof, to name a few. In some embodiments, the defined gap between the first laminate and the second laminate are configured with a negative internal pressure.

In one embodiment, the spacer is metal, plastic, polymeric, and/or a combination thereof. In one embodiment, the spacer includes a desiccant, configured therein. For example, the desiccant is configured to reduce, prevent and/or eliminate presence of moisture (e.g. fog) in the first defined gap and/or second defined gap.

In one embodiment, the first sheet and the second sheet or a laminate (first laminate and/or second laminate) are composed of the same glass composition. In one embodiment, the first sheet and the second sheet of a laminate (first laminate and/or second laminate) are composed of different types of glass (and/or different glass compositions).

In some embodiments, the retrofit window assembly is configured with acoustic dampening; increased insulation, tailored light filtering, safety glazing performance when measured in accordance with ANSI Z97.1 or EN 12600 standards, and combinations thereof.

In some embodiments, the securing step further comprises positioning the frame and at least one glass pane within the existing frame, such that the weight of the secondary glazing system is retained by the existing window frame.

In some embodiments, the sealing engagement further comprises positioning the secondary glazing system alongside the existing frame, such that the weight of the secondary glazing system is retained by the attachment member to the attachment locations along the existing window frame.

In some embodiments, the fenestration apparatus is configured for improved acoustic performance, as measured by the sound transmission class (STC) of ASTM E413 or outdoor-indoor transmission class (OITC) of ASTM E1332.

In some embodiments, the fenestration apparatus is configured with an improved optical clarity. In some embodiments, the fenestration apparatus is configured with lightweight design. In some embodiments, the fenestration apparatus is configured with improved scratch resistance.

In some embodiments, the fenestration apparatus is configured for removable attachment, to enable cleaning of the panels, seasonal management, and/or ease in installation with reduced breakage.

Non-limiting examples of some additional improved fenestration apparatus performance criterion (as compared to the existing fenestration assembly) include at least one of: acoustic dampening (e.g. improved/reduced sound transmittance through the fenestration assembly); safety performance (e.g. in compliance with safety rating or improved/reduced weight with thin center pane and in compliance with safety rating); improved/reduced solar heat gain coefficient; improved dimensions (e.g. reduced weight and/or reduced or maintained cross-sectional thickness); emissivity (e.g. improved/reduced emissivity with application or one or more low emissivity coatings); insulation (e.g. improved/reduced thermal transfer (hot or cold) from one end of the fenestration assembly to the other end, through the cross-sectional width); light transmittance (improved/reduced light transmittance and/or improved filtering of one or more types of light); modular drop-in configuration (e.g. present embodiment having same dimensional configuration as existing window, with minimal need for window mounting re-work in instances of retrofitting); and/or combinations thereof.

In some embodiments, solar heat gain coefficient is quantified and/or measured in accordance with ANSI/NFRC 200 Procedure for Determining Fenestration Product Solar Heat Gain Coefficient and Visible Transmittance at Normal Incidence. In some embodiments, thermal insulation (U-value) is quantified and/or measured in accordance with ASTM E1423 Standard Practice for Determining Steady State Thermal Transmittance of Fenestration Systems and/or ANSI/NFRC 100 Procedure for Determining Fenestration Product U-factors.

In some embodiments, the fenestration apparatus comprises a laminate configured to pass safety glazing standards in accordance with at least one of: ANSI Z97.1 or EN 12600 standards, thereby providing additional safety and security to the inhabitants.

In some embodiments, low emissivity coatings (e.g. silver-containing low-e coatings), in conjunction with a sealed gas cavity, are utilized to provide/promote improved thermal properties.

The use of an SGS provides improvements in energy performance (and therefore cost), acoustics, and occupant comfort over existing single pane windows. The present disclosure provides light weight retrofit options, and hence ease of installation and removal. This in turn leads to lower initial installation costs and lower maintenance costs. The lower weight is compatible with a wider range of existing building structures, which may not be able to large loads of thick glass.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings.

FIG. 1A depicts a schematic cut-away side view of an embodiment of a liquid crystal window glazing device having a liquid crystal panel incorporated in a glazing and further, having a removably attachable attachment member configured for removable engagement with an existing fenestration structure, in accordance with one or more embodiments of the present disclosure.

FIG. 1B depicts a schematic cut-away side view of an embodiment of an insulating glazing unit having a first glazing comprising a liquid crystal panel and a second glazing comprising a laminate, having a removably attachable attachment member configured for removable engagement with an existing fenestration structure, in accordance with one or more embodiments of the present disclosure.

FIG. 1C depicts a schematic cut-away side view of an embodiment of an insulating glazing unit having a first glazing comprising a liquid crystal panel and a second glazing comprising a single layer, having a removably attachable attachment member configured for removable engagement with an existing fenestration structure, in accordance with one or more embodiments of the present disclosure.

FIG. 2A depicts a schematic partial cut-away side view of an embodiment of a liquid crystal window glazing device, depicting the LCW glazing device removably attached to an existing fenestration assembly (here, depicted as an existing window), where the LC window glazing device is retained within the existing frame via compressive engagement via the compression member with the existing window ledge, such that the LCW glazing device is configured for removable engagement with an existing fenestration structure, in accordance with one or more embodiments of the present disclosure.

FIG. 2B depicts a schematic partial cut-away side view of an embodiment of a liquid crystal window glazing device, depicting the LCW glazing device removably attached to an existing fenestration assembly (here, depicted as an existing window), where the LC window glazing device is retained adjacent to the existing window and existing window frame via mechanical attachment to the existing window frame (and/or area surrounding the existing fenestration assembly) via the mechanical attachment member, such that the LCW glazing device is configured for removable engagement with an existing fenestration structure, in accordance with one or more embodiments of the present disclosure.

FIG. 2C depicts a schematic partial cut-away side view of an embodiment of a liquid crystal window glazing device, depicting the LCW glazing device removably attached to an existing fenestration assembly (here, depicted as an existing window), where the LC window glazing device is retained adjacent to the existing window and existing window frame via a combination of attachment members, including (a) mechanical attachment to the existing window frame (and/or area surrounding the existing fenestration assembly) via the mechanical attachment member, such that the LCW glazing device is configured for removable engagement with an existing fenestration structure; and (b) compressive retention within the existing frame via compressive engagement via the compression member with the existing window ledge, in accordance with one or more embodiments of the present disclosure.

FIG. 3 depicts a schematic partial cut-away side view of an embodiment of a liquid crystal window glazing device, depicting the LCW glazing device configured for communication with a control system (e.g. wired or wireless) and a remote power source (i.e. configured to cooperate with the wireless power receiver onboard the LCW glazing device such that the LCW is configured in a substantially wireless manner (e.g. minimal onboard wiring), in accordance with one or more embodiments of the present disclosure.

### DETAILED DESCRIPTION OF THE DRAWINGS

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

The LC glazing device and/or IGUs, as detailed herein, are configured for retrofitting existing fenestration assemblies, and as such, are configured for removable engagement, i.e. not a permanent fixture to the fenestration assembly. The LC glazing device is configured to be removable for seasonal needs/weather changes, modular updates to portions of buildings when an increase in occupant privacy is desired, and/or removed for cleaning of the LCW glazing device and/or the existing window and/or ledge, which can accumulate dirt, debris, moisture, and/or other non-desirable items. Additionally, the LC glazing device and/or IGUs as described in one or more embodiments of the present disclosure can be configured to provide tailored advantages to energy consumption and/or user experience in the building, including, but not limited to: improved visible light transmission, improved solar heat gain coefficient, improved glare, improved work surface illuminance, improved acoustic dampening, improved thermal performance, improved impact resistance, improved safety performance, and/or other improved attributes, as described and advantaged herein.

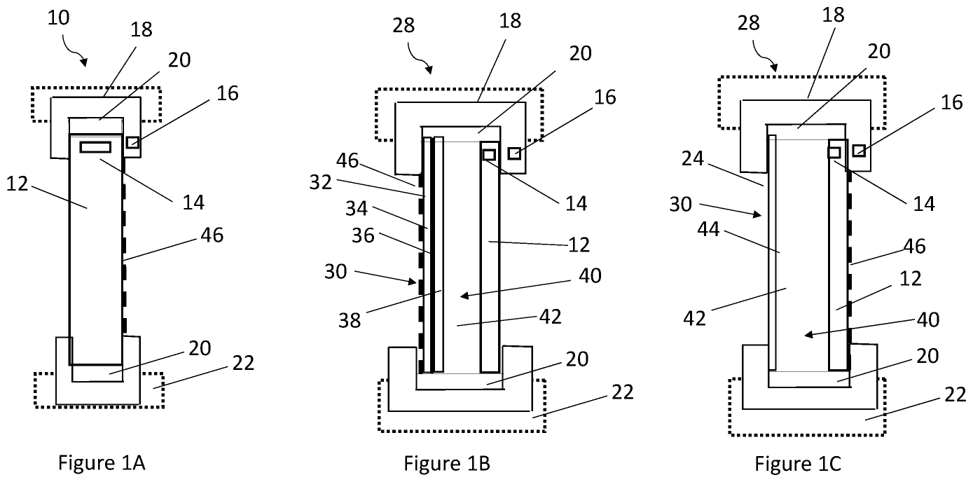

FIG. 1A depicts a schematic cut-away side view of an embodiment of a liquid crystal window glazing device 10 having a liquid crystal panel 12 incorporated in the glazing unit and further, having a removably attachable attachment member 22 configured for removable engagement with an existing fenestration structure 62.

Referring to FIG. 1A, an LCW glazing device 10 having an LC panel 12 is shown. The LC panel is configured with a liquid crystal material retained between at least two panes of glass and configured with interlayers to promote uniform electric functionality when an electric field is propagated from the power source 16 through the electrodes 14, and through the LC material retained in the LC panel, thus actuating a change in contrast of the LC panel, from a first transmission state to a second transmission state. The LC panel 12 is configured with a coating 46 on a major surface of the LC panel. Though only one side is shown coated in FIG. 1A, both sides are configurable with coatings (the same coating and/or different coatings, as detailed herein). It is noted, the electrodes 14 are represented in illustrations in the perimeter of the LC panel for illustrative purposes only.

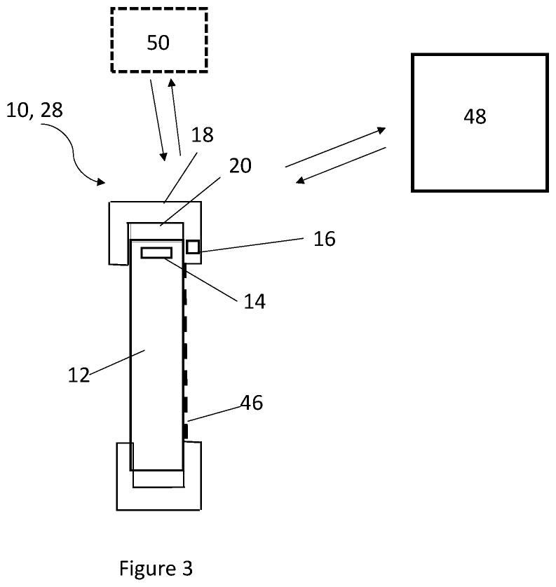

The LC panel 12 is configured with a frame 20 (e.g. around at least a portion of the edge(s) of the LC panel 12, or perimetrically configured around the perimetrical edge of the LC panel 12. As shown in FIG. 1A, the frame 18 has a seal 20 configured therein and positioned between the frame 18 and the edge of the LC panel, to provide secure restraint to the LC panel 12 within the frame 18 and/or a cushion between the frame 18 and the LC panel 12. The frame 18 is configured with an attachment device 22, which is configured to provide removable attachment to an existing fenestration assembly. Additionally, the frame is configured with a power source 16, configured to communicate with the electrodes/electrical connection 14 to the LC panel and actuate a change in visible light transmission (via directing an electric field across the LC material retained therein). In some embodiments, the power source 16 is configured as a wireless power source receiver, such that the power source 16 can communicate and/or receive power wirelessly from an externally located power source (see, e.g. FIG. 3). In some embodiments, the power source 16 is configured as an on-board battery.

FIG. 1B depicts a schematic cut-away side view of an embodiment of an insulating glazing unit (IGU) 28 having a first glazing comprising an LC panel 12 and a second glazing 30. As shown in FIG. 1B, the second laminate 30 is configured in spaced relation from the first glazing (e.g. LC panel 12), to provide a sealed gap 40 therebetween. As shown, the sealed gap 40 is configured with an insulating gas 42 to promote improved thermal performance in the IGU 28 when configured as a retrofit, supplemental window glazing.

As shown in FIG. 1B, the second glazing 30 is configured with a first layer 34 (e.g. glass layer) a second layer 38 (e.g. glass layer) and an interlayer 36 positioned between the first layer 34 and the second layer 38 and configured to attach and/or adhere the first layer 34 and second layer 38 together.

The IGU 28 of FIG. 1B similarly depicts the first glazing (LC panel 12), insulating gas 42, and second glazing 30 (laminate 32) retained in spaced relation via the frame 18 and seal 20 configured around an edge of the IGU 28. In some embodiments, the IGU 28 seal 20 further includes a spacer configured between the first glazing/LC panel 12 and second glazing 30 to define the sealed gap 40 therein and promote uniform spacing between the two glazings (12 and 30).

Similar to FIG. 1A, FIG. 1B depicts an on board power source 16 retained within the IGU 28 (here, shown as retained in or on the frame 18), an electrical connection/electrodes 14 configured to direct an electrical field across the LC material retained within the LC panel 12 to thereby actuate a change in visible light transmission, and a coating 46 shown on the first layer 34 of the laminate 32 second glazing 30.

In some embodiments, the laminate is configured as a thin (e.g. less than 3.5 mm thick) such that the IGU 28 is configured with an improved weight (light weight as compared to thicker alternatives above 3.5 mm) and/or improved acoustic performance (e.g. measured as acoustic dampening).

Although the coating 46 is depicted on one surface of the IGU 28 depicted in FIG. 1B, it's noted that all four of the surfaces may be coated with a coating 46 (i.e. each individual surface having a coating 46, three surfaces having a coating, two surfaces having a coating 46, or alternative configurations of one coating 46 (e.g. within the sealed gap 40 on second glazing 30 or LC panel 12, or on the LC panel 12 surface not in contact with the sealed gap 40.

FIG. 1C depicts a schematic cut-away side view of an embodiment of an insulating glazing unit (IGU) having a first glazing comprising a liquid crystal panel 12 and a second glazing 30 comprising a single layer 44, having a removably attachable attachment member 22 configured for removable engagement with an existing fenestration structure 62.

As shown in FIG. 1C, the second glazing 30 is configured with as a single layer or pane of glass 44. The IGU 28 of FIG. 1C similarly depicts the first glazing (LC panel 12), insulating gas 42, and second glazing 30 (glass layer 44) retained in spaced relation via the frame 18 and seal 20 configured around an edge of the IGU 28. In some embodiments, the IGU 28 seal 20 further includes a spacer configured between the first glazing/LC panel 12 and second glazing 30 to define the sealed gap 40 therein and promote uniform spacing between the two glazings (12 and 30).

FIG. 1C depicts an on board power source 16 retained within the IGU 28 (here, shown as retained in or on the frame 18), an electrical connection/electrodes 14 configured to direct an electrical field across the LC material retained within the LC panel 12 to thereby actuate a change in visible light transmission, and a coating 46 shown on the first layer 34 of the laminate 32 second glazing 30.

In some embodiments, the second glazing 30 is configured as a thick float glass, having a thickness of at least 2 mm to not greater than 8 mm. In some embodiments, the second glazing comprises a soda lime glass having a thickness of 3 mm to 6 mm thick.

In some embodiments, when the second glazing is configured as a thick float glass, the window is configured with an improved acoustic performance (acoustic dampening).

In some embodiments, when the second glazing is configured at a thickness of greater than 2 mm thick, the glazing is heat strengthened, thus performing in accordance with safety and/or impact resistance standards.

In some embodiments, the second glazing 30 is configured as a thin fusion glass, having a thickness of not greater than 2 mm to not less than 0.5 mm thick. In some embodiments, the second glazing comprises a boro-aluminosilicate glass. In some embodiments, the second glazing comprises a boro-aluminosilicate glass having a thickness of at least 0.5 mm to not greater than 1.3 mm thick.

In some embodiments, when the second glazing 30 is configured as a thin fusion glass, the overall IGU 28 is configured with a lower weight (improved load) than with a glass having a larger thickness. In some embodiments, when the second glazing is a thin fusion glass, the IGU 30 float glass, the window is configured with a pristine surface, having improved clarity.

Although the coating 46 is depicted on one surface of the IGU 28 depicted in FIG. 1C, it's noted that all four of the surfaces may be coated with a coating 46 (i.e. each individual surface having a coating 46, three surfaces having a coating, two surfaces having a coating 46, or alternative configurations of one coating 46 (e.g. within the sealed gap 40 on second glazing 30 or LC panel 12, or on the LC panel 12 surface not in contact with the sealed gap 40.

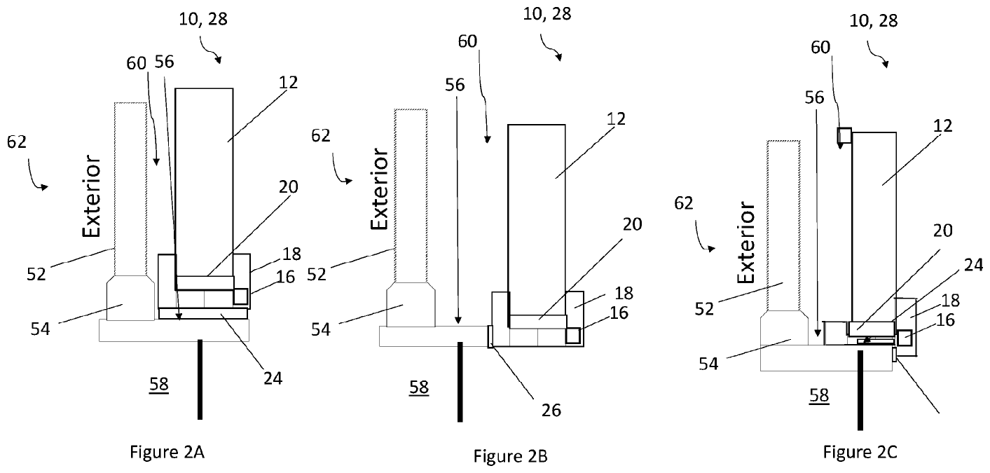

FIGS. 2A through 2C depict various configurations showing where, relative to the existing fenestration structure 62, the LCW glazing device or IGU 28 are configured.

FIGS. 2A through 2C depict a generic configuration of an LC panel 12, configured either as a LCW glazing device 10 (as in FIG. 1A) or as an IGU 28 having at least two panes (e.g. FIG. 1B having the second glazing configured as a laminate and FIG. 1C having the second glazing configured as a single pane in an IGU with the LC panel). Since each of FIGS. 1A-1C are configured with an LC panel 12, a frame 18, a seal 20, and a power source/wireless power receiver 16, the particular components of the architectural glazings/IGU configuration is genericized across FIGS. 2A-2C.

Each of FIG. 2A, FIG. 2B, and FIG. 2C depict an embodiment of an LCW glazing device of IGU having an LC panel 12 configured on an existing fenestration assembly 62 (shown as an existing window 52). For illustrative purposes, the existing fenestration assembly 62 is configured with an existing window 52 retained by an existing frame 54, the existing frame 54 being retained within a fenestration structure (building) to define a window, as compared to the surrounding area surrounding the fenestration assembly 58. Further, the existing frame 54 is configured with an existing window ledge 56, which is configured in a recessed manner (e.g. perimetrically recessed around an edge of the existing window 52) as compared to the area surrounding the fenestration assembly 58.

FIG. 2A depicts a schematic partial cut-away side view of an embodiment of a liquid crystal window glazing device 10, depicting the LCW glazing device 10 in a removably attached position, thereby engaged with an existing fenestration assembly 62 (here, depicted as an existing window 52), where the LC window glazing device 10 is retained within the existing frame 54 via compressive engagement via the compression member 24 with the existing window ledge 56 of the existing window frame 54, such that the LCW glazing device 10 is configured for removable engagement with an existing fenestration structure 62. As shown in FIG. 2A, via the configuration of the LCW glazing device 10 or IGU 28 within the existing fenestration assembly 62 via compression member 24, the weight of the LCW glazing device 10 or IGU 28 is loaded onto the existing fenestration assembly 62.

FIG. 2B depicts a schematic partial cut-away side view of an embodiment of a liquid crystal window glazing device 10, depicting the LCW glazing device 10 removably attached to an existing fenestration assembly 62 (here, depicted as an existing window 52 with existing window frame 54 and area surrounding the fenestration assembly 58), where the LC window glazing device 10 is retained adjacent to the existing window 52 and existing window frame 54 via mechanical attachment member 26 configured in removable attachment to the existing window frame 54 (and/or area surrounding the existing fenestration assembly 56). As such, the LCW glazing device 10 is configured for removable engagement with an existing fenestration structure 62.

As shown in FIG. 2B, via the configuration of the LCW glazing device 10 or IGU 28 via mechanical attachment member 26 to the existing fenestration assembly 62, the weight of the LCW glazing device 10 or IGU 28 is loaded onto the areas of mechanical attachment members 26 which are attached to the existing window frame 54 or area surrounding the fenestration assembly 58.

FIG. 2C depicts a schematic partial cut-away side view of an embodiment of a liquid crystal window glazing device 10, depicting the LCW glazing device removably 10 attached to an existing fenestration assembly 62 (here, depicted as an existing window 52 with existing window frame 54 and area surrounding the fenestration assembly 58), where the LC window glazing device 10 is retained adjacent to the existing window 52 and existing window frame 54 via a combination of attachment members, including: (a) mechanical attachment to the existing window frame 54 (and/or area surrounding the existing fenestration assembly 58) via the mechanical attachment member 26, such that the LCW glazing device 10; and (b) compressive retention within the existing frame 54 via compressive engagement via a compression member 24 with the existing window ledge 56 of the existing window frame 54, such that the LCW glazing device is configured for removable engagement with an existing fenestration structure 62.

As shown in FIG. 2C, via the configuration of the LCW glazing device 10 or IGU 28 via the combination of compression member 24 and mechanical attachment member 26 to the components of the existing fenestration assembly 62, the weight of the LCW glazing device 10 or IGU 28 is loaded onto both the existing window frame 54 via the existing window ledge 56 and the mechanical attachment site between the existing window frame 54 (or area surrounding the frame 58) and the mechanical attachment members 26.

FIG. 3 depicts a schematic partial cut-away side view of an embodiment of a liquid crystal window glazing device 10 or IGU 28, depicting the LCW glazing device 10 configured for communication with a control system 48 (e.g. wired or wireless) and a remote or wireless power source 50 (i.e. configured to cooperate with the wireless power receiver 16 onboard the LCW glazing device 10 such that the LC panel 12 is configured in a substantially wireless manner (e.g. minimal onboard wiring). As depicted in FIG. 3, the LC panel 12 is configured with an electrical connection/electrodes 14 to direct an electric field across an LC material retained within the LC panel 12, thus actuating the LC material to change the visible light transmission from a first contrast to a second contrast. The IGU 28 or LCW glazing device 10 is retained in a frame 18 having a seal 20 therein. Further, the frame 18 is configured with a power source in the form of a wireless power receiver 16.

As shown in FIG. 3, the IGU 28 or LCW glazing device 10 is configured to electrically communicate with control system 48. Control system 48 is configured to direct signals to and receive signal(s) from the LCW glazing device 10 or IGU 28 to control one or more aspects of the LCW glazing device 10 or IGU 28. Also, the wireless power receiver 16 is configured to receive power communicated by the power source with transmitter device 50 to generate a time-varying electromagnetic field which transmits power to the power receiver 16 configured to extract power from the electric field and supply it to an electrical connection/electrodes 14. Without being bound by any particular mechanism or theory, an additional mode of wireless power transmission is resonant induction recharging.

Similarly, in instances where the existing fenestration assembly 62 (existing window 52) is an architectural feature (e.g. stained-glass window, leaded glass, or other aesthetically pleasing architectural features), the LCW glazing device and/or IGUs detailed herein are configured to preserve the architectural aspects of the building and its components while providing improved performance (e.g. acoustics, energy) and a smooth interior/user facing surface (e.g. protecting aesthetic feature(s) from strikes or damage from users inside the building and/or providing a smooth/improved cleaning surface).

In some embodiments, the LC panel includes an LC cell laminated to corresponding glass layers, wherein the first glass layer is attached to a first major surface of the liquid crystal cell via a first interlayer; further wherein the second glass layer is attached to a second major surface of the LC cell via a second interlayer. In some embodiments, the LC cell, as described herein, can include two panes of glass with an LC material configured therebetween.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. As a non-limiting example, about means less than 10% of the referenced value.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Many variations and modifications may be made to the above-described embodiments of the disclosure without departing substantially from the spirit and various principles of the disclosure. All such modifications and variations are intended to be included herein within the scope of this disclosure and protected by the following claims.

1. A fenestration apparatus, comprising:
at least one glazing comprising a liquid crystal panel (LC panel), wherein the liquid crystal panel (LC panel) comprises:
a first glass layer; a second glass layer, and a liquid crystal cell therebetween;
a frame, configured perimetrically around a corresponding perimetrical edge of the LC panel;
a seal, configured between the frame and the LC panel; and
an attachment member configured to the frame, wherein the attachment member is configured to be removably fixable to an existing window, wherein the attachment member is configured to define a gap between the frame, the at least one LC panel, and the existing window.

2. The apparatus of claim 1, wherein the attachment member comprises a compression member.

3. The apparatus of claim 1 or 2, wherein the attachment member comprises an expandable gasket and a release member.

4. The apparatus of claim 1, wherein the attachment member comprises a mechanical attachment member, wherein the mechanical attachment member is configured to cooperate in mating engagement with a corresponding existing fenestration assembly.

5. The apparatus of claim 1, wherein the frame is configured with a base, configured to retain on an existing window frame and/or alongside an existing window frame assembly.

6. The apparatus of claim 1, wherein the frame is configured with at least two upward extensions along the perimetrical edge of the glass laminate, such that the first extension is configured alongside the first glass layer and the second extension is configured alongside the second glass layer.

7. The apparatus of claim 1, wherein the existing window comprises an adjacent perimetrical ledge/extension.

8. The apparatus of claim 1, wherein the fenestration assembly further comprises a wireless power member.

9. The apparatus of claim 1, wherein the fenestration assembly further comprises a second glazing in spaced relation from the first major surface of the LC panel, wherein the second glazing and the LC panel define a gap therebetween.

10. The apparatus of claim 9, wherein the second glazing is a single layer of glass, or a glass laminate.

11. The apparatus of claim 10, wherein the second glazing comprises a third layer of glass and a fourth layer of glass retained together with a third interlayer.

12. The apparatus of claim 11, wherein the third layer of glass and fourth layer of glass are each selected from:
a. strengthened boro-aluminosilicate glass,
b. unstrengthened boro-aluminosilicate glass,
c. strengthened soda lime glass, and
d. unstrengthened sodalime glass.

13. The apparatus of claim 10, wherein at least one of the third layer and fourth layer comprise a boro-aluminsilicate glass having a thickness of not greater than 1 mm.

14. The apparatus of claim 10, wherein at least one of the third layer and fourth layer comprise a soda lime glass having a thickness of between 2 mm and 6 mm.

15. The apparatus of claim 10, wherein the third interlayer is selected from:
a polyester, a polyurethane, an ionomer, and/or combinations thereof.

16. The apparatus of claim 10, wherein the second glazing comprises a layer of boro-aluminosilicate glass having a thickness of between 0.5 mm and not greater than 1 mm.

17. The apparatus of claim 10, wherein the second glazing comprises a single layer of soda lime glass having a thickness selected from the range of between 2 mm and not greater than 6 mm.

18. The apparatus of claim 1, wherein the first interlayer and second interlayer each comprise a thickness of not greater than 2.5 mm.

19. The apparatus of claim 1, wherein the first interlayer and second interlayer each comprise a polymer.

20. The apparatus of claim 1, wherein the first interlayer and second interlayer are each selected from: a polymer, a polyester, a polyurethane, an ionomer, and/or combinations thereof.

21.-50. (canceled)
